(19) United States
(12) Patent Application Publication
(10) Pub. No.: US 2008/0291485 A1
(43) Pub. Date: Nov. 27, 2008

(54) DRIVER APPARATUS, SETTING INFORMATION MANAGEMENT METHOD, SETTING INFORMATION MANAGEMENT PROGRAM

(75) Inventors: Yuko Kimoto, Kanagawa-ken (JP); Naoki Hoshino, Saitama-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/753,615

(22) Filed: May 25, 2007

(51) Int. Cl. G06F 3/12

(52) U.S. Cl. 358/1.15

(57) ABSTRACT

To provide a technique that can contribute to improvement of operability in performing management of setting contents in a driver apparatus that causes an image processing apparatus to execute plural functions executable in the image processing apparatus on the basis of setting contents registered for respective functions.

A driver apparatus that causes an image processing apparatus to execute plural functions executable in the image processing apparatus on the basis of setting information registered for the respective functions includes an identification-information acquiring unit that acquires identification information for identifying a user, a display-information acquiring unit that acquires information on at least one of the setting information and data registered in association with the identification information acquired by the identification-information acquiring unit, and a display control unit that causes the image processing apparatus to display display objects associated with the information acquired by the display-information acquiring unit in a predetermined display area as a list.

### BACKGROUND OF THE INVENTION

1. Field of the Invention

The present invention relates to a technique for improving operability of a setting screen in a driver apparatus that causes an image processing apparatus to execute plural functions executable in the image processing apparatus on the basis of setting contents registered for the respective functions.

2. Description of the Related Art

Conventionally, there is known a “template function” for facilitating setting operation and a function for registering desired setting contents as “favorite setting” in advance in a driver apparatus that causes an image processing apparatus to execute plural functions executable in the image processing apparatus on the basis of setting contents registered for the respective functions.

However, in the conventional driver apparatus, various templates in the “template function” and various setting contents in the “favorite setting” are set for the respective functions such as a print function and a facsimile function. In order to confirm these setting contents, it is necessary to individually confirm the setting contents on setting screens corresponding to the respective functions. In such a conventional driver apparatus, when it is desired to comprehensively manage each of setting contents set for functions different from one another, it is impossible to efficiently refer to the setting contents. Thus, there is a problem in terms of operability.

### SUMMARY OF THE INVENTION

It is an object of an embodiment of the invention to provide a technique that can contribute to improvement of operability in performing management of setting contents in a driver apparatus that causes an image processing apparatus to execute plural functions executable in the image processing apparatus on the basis of setting contents registered for respective functions.

In order to solve the problem, a driver apparatus according to an aspect of the invention is a driver apparatus that causes an image processing apparatus to execute plural functions executable in the image processing apparatus on the basis of setting information registered for the respective functions. The driver apparatus is characterized by including an identification-information acquiring unit that acquires identification information for identifying a user, a display-information acquiring unit that acquires information on at least one of the setting information and data registered in association with the identification information acquired by the identification-information acquiring unit, and a display control unit that causes the image processing apparatus to display display objects associated with the information acquired by the display-information acquiring unit in a predetermined display area as a list.

A setting information management method according to another aspect of the invention is a setting information management method of performing management of setting information in a driver apparatus that causes an image processing apparatus to execute plural functions executable in the image processing apparatus on the basis of the setting information registered for the respective functions. The setting information management method is characterized by including an identification-information acquiring step of acquiring identification information for identifying a user, a display-information acquiring step of acquiring information on at least one of the setting information and data registered in association with the identification information acquired in the identification-information acquiring step, and a display control step of causing the image processing apparatus to display display objects associated with the information acquired in the display-information acquiring step in a predetermined display area as a list.

A setting information management program according to still another aspect of the invention is a setting information management program for causing a computer to execute management of setting information in a driver apparatus that causes an image processing apparatus to execute plural functions executable in the image processing apparatus on the basis of the setting information registered for the respective functions. The setting information management program is characterized by causing the computer to execute an identification-information acquiring step of acquiring identification information for identifying a user, a display-information acquiring step of acquiring information on at least one of the setting information and data registered in association with the identification information acquired in the identification-information acquiring step, and a display control step of causing the image processing apparatus to display display objects associated with the information acquired in the display-information acquiring step in a predetermined display area as a list.

### DESCRIPTION OF THE DRAWINGS

FIG. 1 is a diagram showing a configuration of an image processing system including a PC 11 and an image processing apparatus 21 according to an embodiment of the invention;

FIG. 2 is an external perspective view for explaining an overview of the image processing apparatus 21 according to the embodiment;

FIG. 3 is a functional block diagram for explaining the PC 11 according to the embodiment;

FIG. 4 is a diagram showing an example of a display screen of a display 11a in the PC 11;

FIG. 5 is a diagram for explaining a portal screen P;

FIG. 6 is a diagram for explaining the portal screen P;

FIG. 7 is a diagram showing an example of a standard print setting screen;

FIG. 8 is a diagram showing an example of a customized setting screen;

FIG. 9 is a flowchart for explaining a flow of processing (a setting-information management method) in the PC 11 according to the embodiment;

FIG. 10 is a diagram showing an interface screen 211 in a state before login of the image processing apparatus 21;

FIG. 11 is a diagram showing an example of a my room screen displayed on the interface screen 211;

FIG. 12 is a diagram showing an example of screen display in the display 11a in a state in which a “MY Log” button on a management screen displayed by depressing a “My Room” button 901 in the portal screen P is depressed;

FIG. 13 is a diagram showing a state in which information to be managed is displayed as icons;

FIG. 14 is a diagram showing a state in which the information to be managed are displayed as a list;

FIG. 15 is a diagram showing a state in which the information to be managed are displayed as icons;

FIG. 16 is a diagram showing a state in which the information to be managed are displayed as a list;

FIG. 17 is a diagram showing a state in which the information to be managed are displayed as icons;

FIG. 18 is a diagram showing a state in which the information to be managed is displayed as a list;

FIG. 19 is a diagram showing a state in which the information to be managed are displayed as icons;

FIG. 20 is a diagram showing a state in which the information to be managed is displayed as a list;

FIG. 21 is a diagram showing a state in which the information to be managed is displayed as icons;

FIG. 22 is a diagram showing a state in which the information to be managed is displayed as a list;

FIG. 23 is a diagram showing an example of a screen displayed as a popup when a setting information icon “1C” is selected; and

FIG. 24 is a diagram showing an example of a screen displayed as a popup when a setting information icon “1F” is selected.

### DESCRIPTION OF THE EMBODIMENTS

An embodiment of the invention will be hereinafter explained with reference to the drawings.

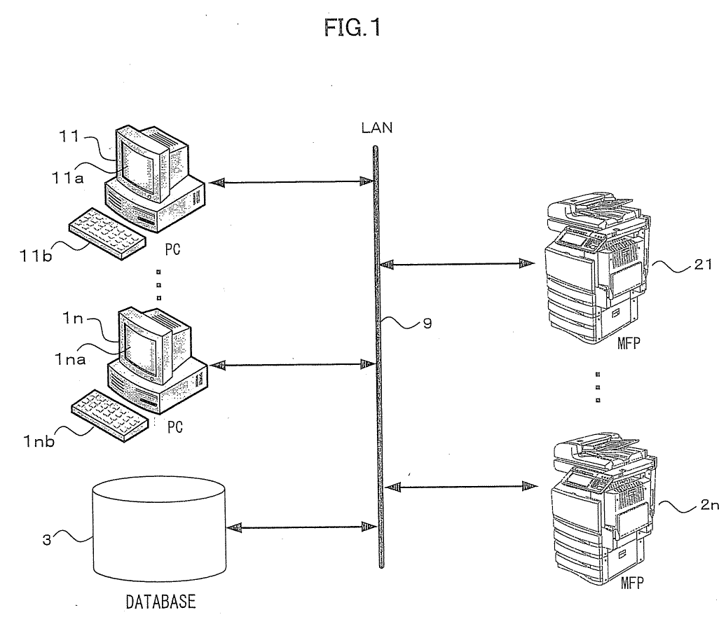

FIG. 1 is a diagram showing a configuration of an image processing system including a PC (including a driver apparatus) 11 and an image processing apparatus 21 according to this embodiment. In the image processing system shown in the figure, PCs (Personal Computers) 11 to 1n, image processing apparatuses 21 to 2n, and a database 3 are connected to be capable of communicating with one another via a telecommunication line such as a LAN 9.

Means for connecting the PCs 11 to 1n, the image processing apparatuses 21 to 2n, and the database 3 to be capable of communicating with one another is explained as the LAN here. However, the means is not limited to this and may be the Internet, a WAN, and the like (the means may be either wired or wireless). The PCs 11 to 1n are capable of performing various kinds of setting concerning an image processing function executable in the image processing apparatuses 21 to 2n and giving, for example, commands for execution of various processing functions to the image processing apparatuses 21 to 2n.

The commands and the like given to the image processing apparatuses 21 to 2n by the PCs 11 to 1n are performed by the driver apparatuses included in the PCs 11 to 1n on the basis of operation inputs performed by users, who look at setting screens displayed on displays 11a to 1na included in the PCs 11 to 1n, using operation inputting units (e.g., keyboards or mouses) 11b to 1nb. The example in which the displays and the operation inputting units are separately provided is cited here. However, the displays and the operation inputting units are not limited to this. For example, the functions of the displays and the operation inputting units may be realized by touch panel displays.

The database 3 has a role of a storage area that stores various kinds of setting information and the like used in the PCs 11 to 1n and the image processing apparatuses 21 to 2n.

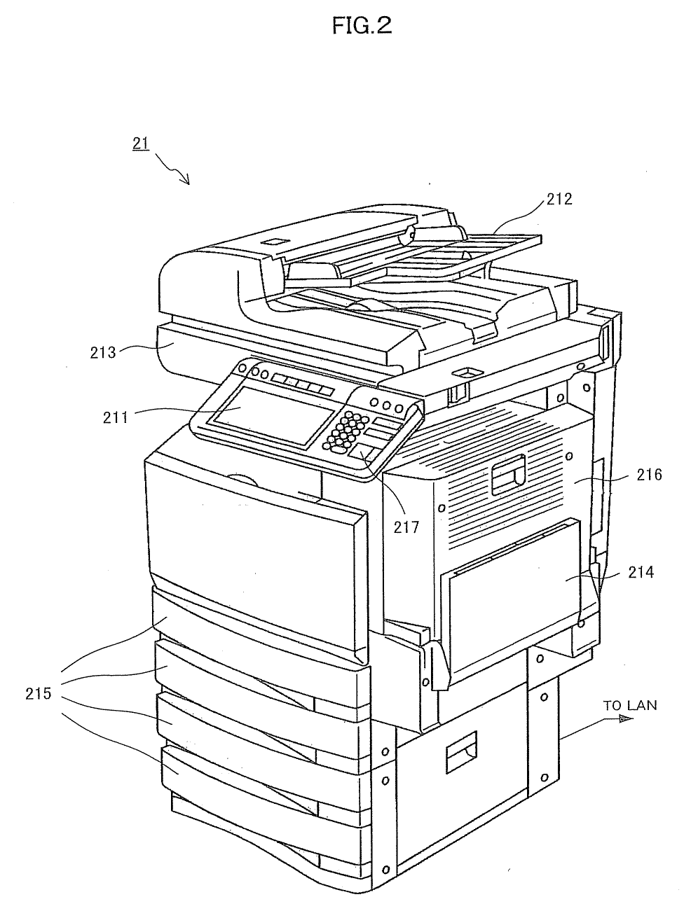

FIG. 2 is an external perspective view for explaining an overview of the image processing apparatus 21 according to this embodiment. Here, as an example, an example in which the image processing apparatus 21 is an MFP (Multi Function Peripheral) is cited.

The image processing apparatus 21 according to this embodiment includes an interface screen 211, an ADF (Auto Document Feeder) 212, an image scanning unit 213, a manual sheet feeing unit 214, sheet feeding cassettes 215, an image forming unit 216, and an authentication processing unit 217.

An example of operations of the image processing apparatus 21 according to this embodiment will be hereinafter briefly explained. When, for example, copy processing (predetermined image processing) is performed in the image processing apparatus 21, first, authentication processing for a user is performed by the authentication processing unit 217. Subsequently, an original set in the ADF 212 is automatically conveyed to a position for original scanning by the image scanning unit 213 on the basis of an operation input to the interface screen 211 by the user who has succeeded in the authentication processing. An image of the original conveyed in this way is scanned by the image scanning unit 213. A sheet feeding operation is performed by any one of the sheet feeding cassettes 215 and the manual sheet feeding unit 214 according to a sheet feeding method selected on the basis of the operation input to the interface screen 211. A sheet fed is conveyed to the image forming unit (an image processing unit) 216 and applied with image formation processing based on the image scanned by the image scanning unit 213. The copy processing is completed.

The interface screen 211 is constituted by, for example, a touch panel display. The interface screen 211 also has a role of an operation inputting unit that accepts an operation input of the user based on display contents on the interface screen 211.

The image processing apparatus 21 is capable of executing plural functions different from one another such as a “print function” of performing print processing on the basis of image data acquired by the image processing apparatus 21, a “facsimile function” of transmitting the image data acquired by the image processing apparatus 21 (image data scanned from an original, image data received from an external apparatus, etc.) to a desired destination by facsimile, a “scan function” of scanning an image of the original, and a “box function” of storing the image data scanned from the original by the “scan function” in the image processing apparatus 21 in a desired storage area. The “box function” is capable of selecting, as a data storage destination (a destination), at least any one of the PCs 11 to 1n and the image processing apparatuses 22 to 2n connected to the image processing apparatus 21 to be capable of communicating with each other. It is possible to realize a copy function by causing the image processing apparatus 21 to execute the “scan function” and the “print function” in combination.

As processing objects of the predetermined processing in the image processing apparatus 21, a sheet original, a book-like original, image data, and the like are cited as examples.

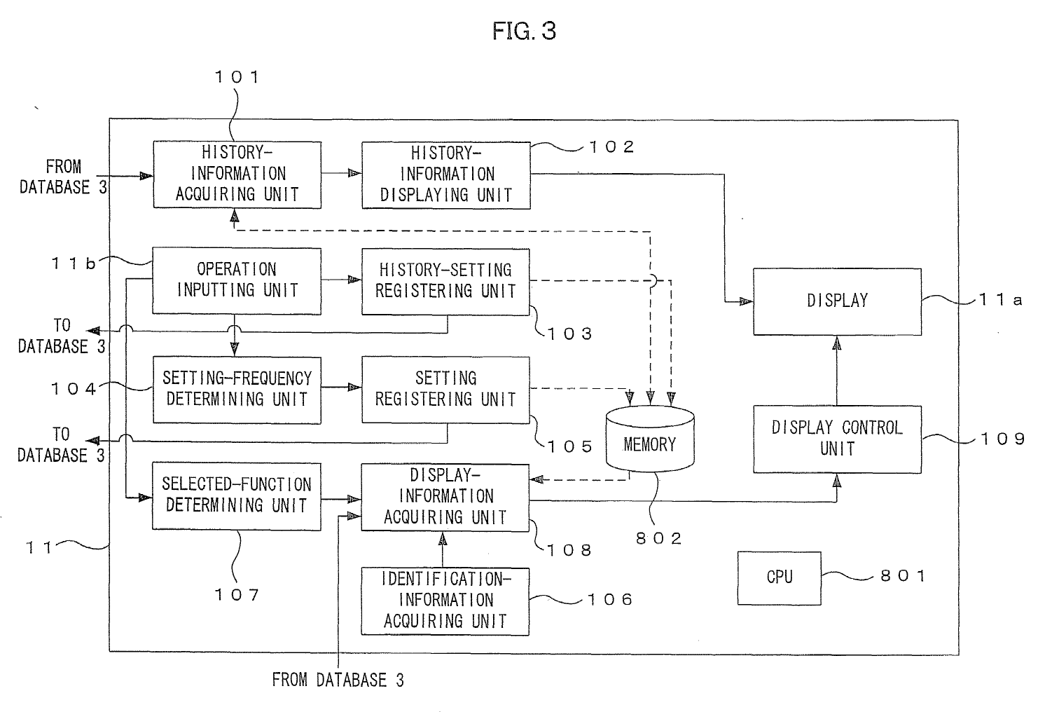

FIG. 3 is a functional block diagram for explaining the PC (the driver apparatus) 11 according to this embodiment. In this embodiment, the PCs 11 to 1n have the same components. The image processing apparatuses 21 to 2n also have the same components. It is possible to realize the image processing system according to this embodiment with any one of the image processing apparatuses 21 to 2n and any one of the PCs 11 to 1n. Thus, functions of the image processing system including the image processing apparatus 21 and the PC 11 will be hereinafter explained in detail as an example.

The PC 11 according to this embodiment causes the image processing apparatus to execute plural functions (e.g., the print function, the facsimile function, the scan function, and the box function) executable in the image processing apparatus on the basis of setting contents set in setting screens corresponding to the respective functions. The PC 11 according to this embodiment causes the image processing apparatus 21 to display plural setting screens for performing setting for each of the plural functions executable in the image processing apparatus 21, which are plural setting screens (a printer driver screen, a facsimile driver screen, a scanner driver screen, etc.) that can display plural setting items in the respective functions on the respective setting screens, such that selection of the setting screens can be switched.

Specifically, the PC 11 according to this embodiment includes a history-information acquiring unit 101, a history-information displaying unit 102, a history-setting registering unit 103, a setting-frequency determining unit 104, a setting registering unit 105, an identification-information acquiring unit 106, a selected-function determining unit 107, a display-information acquiring unit 108, a display control unit 109, a display 11a, an operation inputting unit 11b, a CPU 801, and a MEMORY 802.

The history-information acquiring unit 101 acquires history information concerning a history of setting operation by the user.

The history-information displaying unit 102 displays the history information acquired by the history-information acquiring unit 101.

The history-setting registering unit 103 registers setting information corresponding to history information selected by an operation input of the user among the history information displayed by the history-information displaying unit 102 in, for example, the database 3.

The setting-frequency determining unit 104 determines a setting frequency of setting information by the user.

The setting registering unit 105 registers, in association with the user, setting information determined as being set at a frequency equal to or higher than a predetermined threshold by the setting-frequency determining unit 104 in, for example, the database 3.

The identification-information acquiring unit 106 acquires identification information for identifying the user.

The selected-function determining unit 107 determines, on the basis of an operation input to the operation inputting unit 11b of the user, a function selected by the user among the plural functions (e.g., the print function, the facsimile function, the scan function, and the box function).

The display-information acquiring unit 108 acquires, from an external apparatus (e.g., the database 3) connected to the PC 11 to be capable of communicating with each other, information on at least one of setting information and data registered in association with the identification information acquired by the identification-information acquiring unit 106.

The display control unit 109 causes the PC 11 to display, in association with information on the function determined as being selected by the selected-function determining unit 107, display objects (including at least one of characters and icons) associated with the information acquired by the display-information acquiring unit 108 in a predetermined display area. In this case, the display control unit 109 allocates the display objects to display areas different for each of the functions and causes the PC 11 to display the display objects therein.

The CPU 801 has a role of performing various kinds of processing in the PC 11 and also has a role of realizing various functions by executing programs stored in the MEMORY 802. The MEMORY 802 is constituted by, for example a ROM or a RAM and also has a role of storing various kinds of information and programs used in the PC 11. In this embodiment, an example in which a registering destination of the setting information and the like and an acquiring source of various kinds of information are set in the database 3 is cited. However, the invention is not limited to this and it is also possible to set the registering destination and the acquiring source in, for example, the MEMORY 802 and other external apparatuses.

In this way, the “setting information” indicating the setting contents such as a print setting and a scan setting registered in association with the user and the “data” such as a document file and image data are displayed as a list in the identical display area without being specifically distinguished from each other. Consequently, the user can unitarily manage registered setting information and data related to the user himself/herself. It is possible to contribute to improvement of operability.

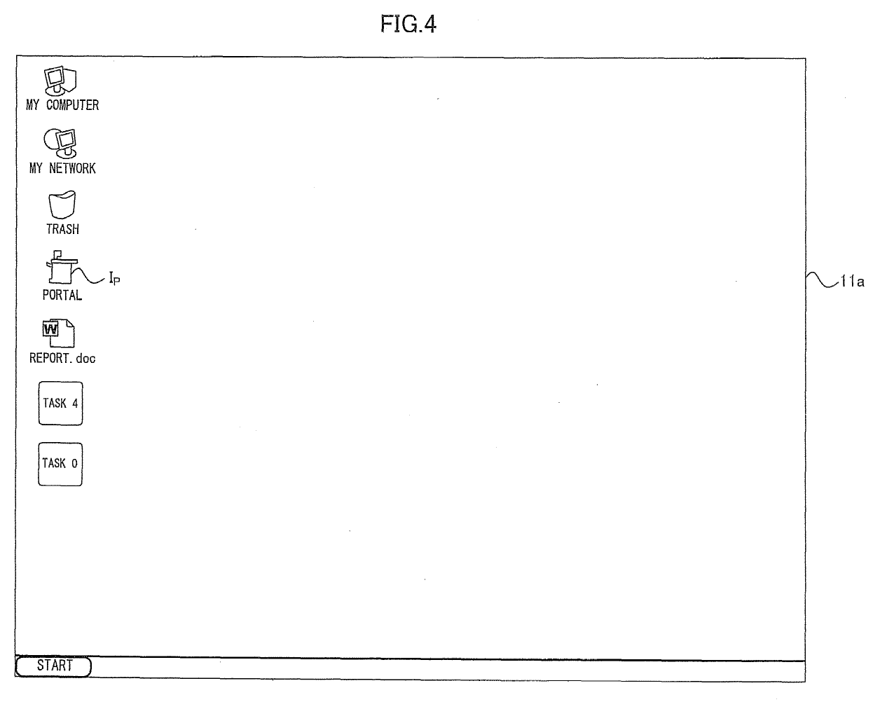

Operations of the driver apparatus according to this embodiment will be explained. First, a method of invoking the respective driver screens and the like will be explained using FIGS. 4 to 8.

FIG. 4 is a diagram showing an example of a display screen of the display 11a in the PC 11. On the display 11a, a “portal” icon Iₚ is displayed together with various icons such as “My Computer” and “My Network”.

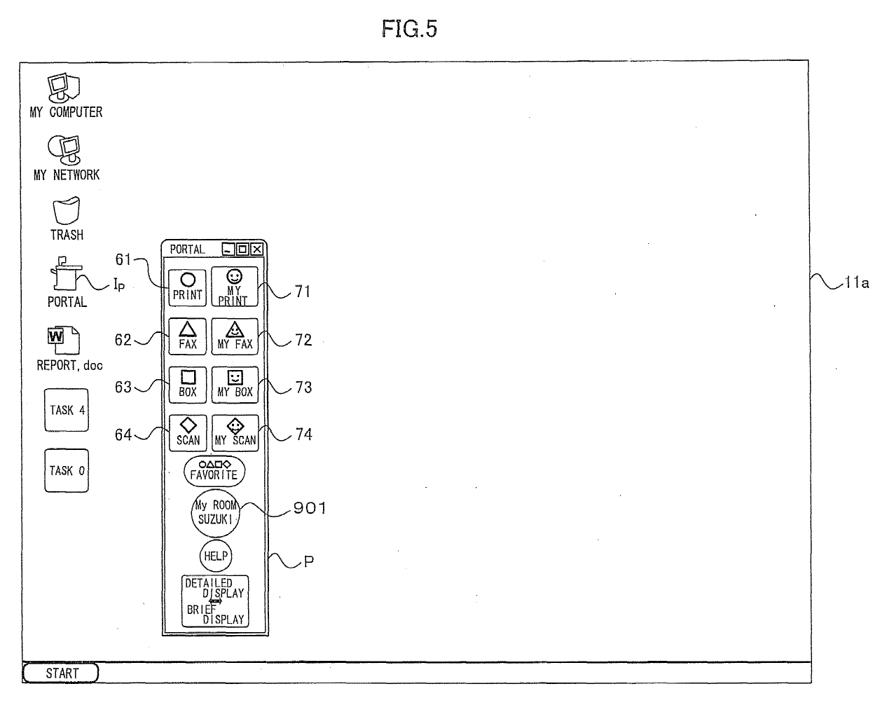

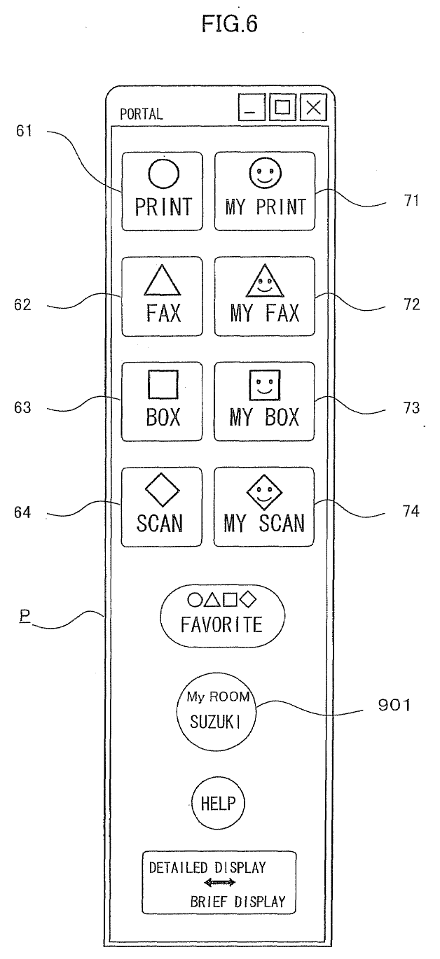

When the user selects this “portal” icon Iₚ with an operation input (doubleclick, etc.) to the operation inputting unit 11b, a portal screen P shown in FIG. 5 is displayed in the screen of the display 11a. FIG. 6 is a diagram showing details of the portal screen P. On the portal screen P, buttons 61 to 64 for opening setting screens (driver screens) for performing the conventional standard function setting, buttons 71 to 74 for opening my setting screens (customized driver screens) corresponding to respective functions that respective users can customize, a “My Room” icon 901 for invoking a management screen (details will be described later) for the user to comprehensively manage setting information indicating setting contents registered for the respective functions, and a “Favorite” button for invoking a list of the setting contents for the respective functions registered in advance are displayed. In this way, on the portal screen P, it is clearly indicated that setting operation is also possible for functions other than the print function executable in the image processing apparatus 21.

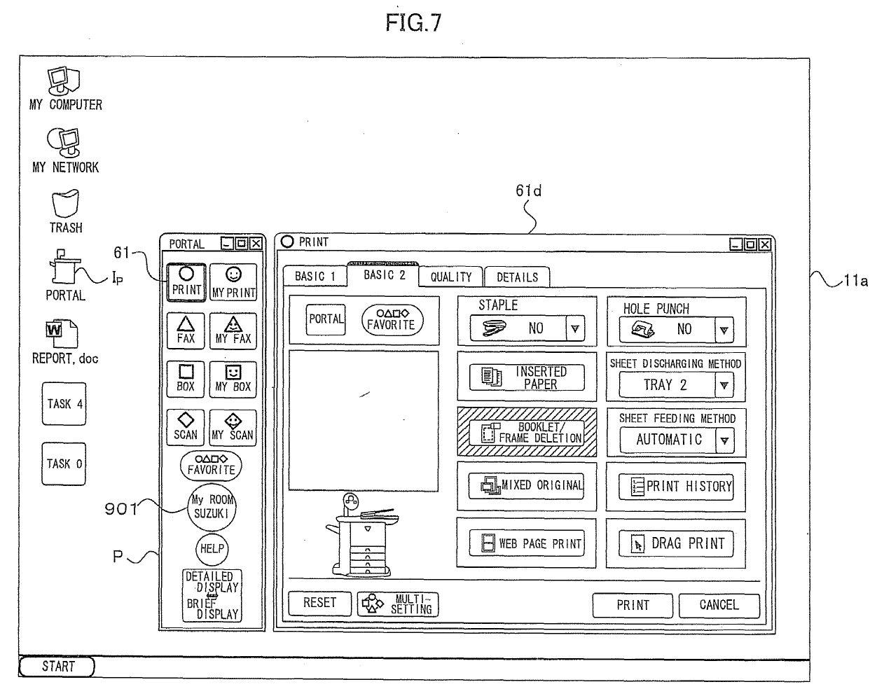

When the user desires to perform, for example, print setting on a standard setting screen for the print function, the user can display a standard print setting screen 61d shown in FIG. 7 by selecting the button 61 with the operation inputting unit 11b (a state in which a button or the like on the screen is selected is represented by surrounding the button with a thick line as shown in FIG. 7).

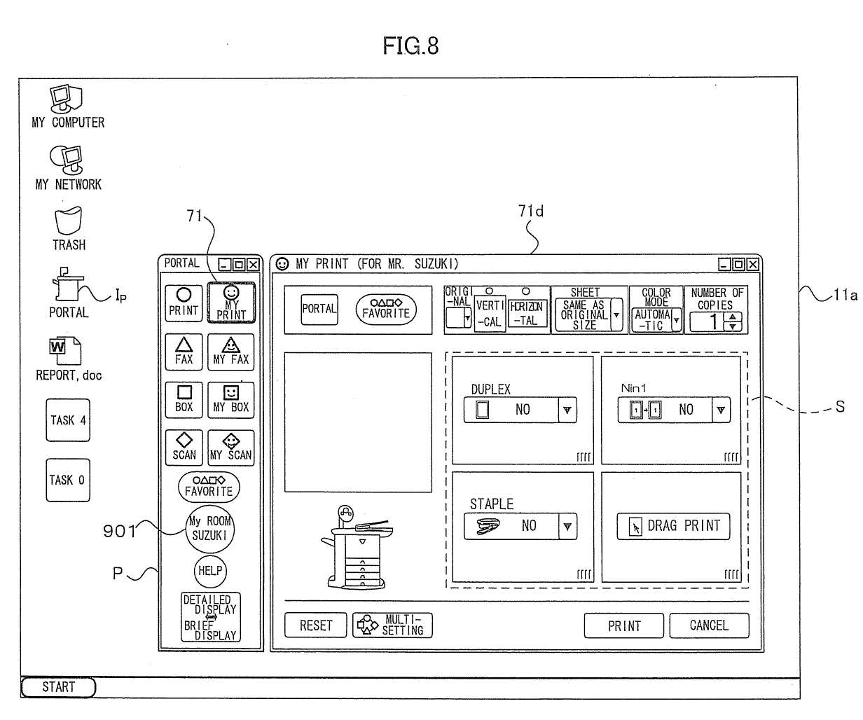

On the other hand, when the user desires to use a customizable print setting screen, the user selects the button 71 with the operation inputting unit 11b. Then, as shown in FIG. 8, a setting screen in which setting items (setting items that should be displayed in the setting screen) registered to be associated with the user in advance for the print function are arranged in a display area S is displayed.

In this way, only setting items that should be displayed in the setting screen among the various setting items corresponding to the plural functions of the image processing apparatus are selectively displayed in the display area S of the setting screen. Consequently, it is possible to improve brief graspability of the various setting items at a glance and display the setting items on a screen and it is possible to provide an interface screen on which the user can easily perform setting.

The number of setting items displayed in the display area S at a time can be set to a predetermined number in default. However, the number of setting items may be arbitrarily set on the basis of an operation input of the user. A size of icon images and the like of the setting items displayed as a list in the display area S and a size of characters indicating the respective setting items are changed according to the numbers of the setting items displayed (e.g., when the number of items is small, an area used for one item is increased to increase the character size). This makes it possible to further contribute to improvement of visibility of the respective setting items.

As described above, even different setting items generally displayed in separate tabs in the printer driver and setting items usually located in deep hierarchies (e.g., setting items generally having low frequencies of use) are registered as display objects in the setting screen if frequencies of use of the setting items are high. This leads to improvement of visibility and operability in setting work.

A procedure for registering setting items in display objects using the operation inputting unit 11b will be explained.

In the state in FIG. 7, when the user selects the “My Print” button 71 in the portal screen P, a print setting screen 71d and the standard print setting screen 61d are simultaneously displayed.

The user drags, with a mouse or the like, a setting item (here, “staple” is selected) that the user desires to display in the display area S in the print setting screen 71d (desires to add to setting items of the setting screen for the user) out of the plural setting items displayed on the print setting screen 61d in this way, moves the setting item to the display area S in the print setting screen 71d, and drops the setting item in the display area S.

By performing the drag and drop operation described above, the user can register the desired setting item in the display objects in the display area S in the print setting screen 71d. This makes it possible to customize a setting screen with a higher degree of freedom.

In this embodiment, setting items that can be registered in the display objects in the display area S in the print setting screen 71d by the drag and drop operation are displayed with a light background color in the print setting screen 61d and setting items that cannot be registered (cannot be dragged and dropped) are displayed with a dark background color (see, for example, “booklet/frame deletion” in FIG. 7). Consequently, the user can visually grasp the setting items that can be registered as display objects in the display area S in the print setting screen 71d.

Management of setting information set by using the setting screen described above in the PC 11 (the driver apparatus) according to this embodiment will be explained.

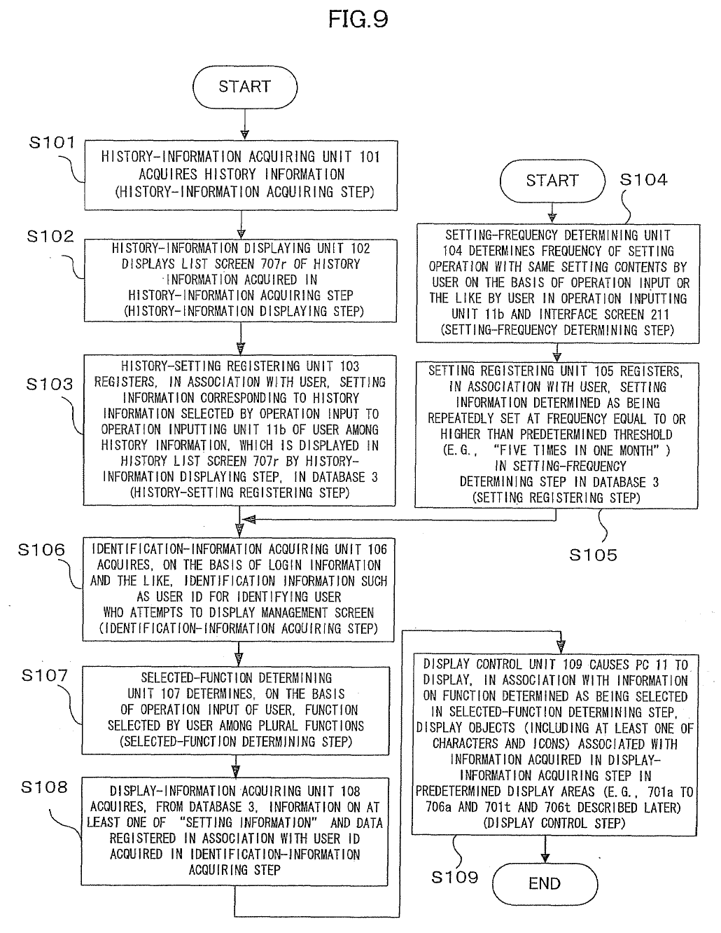

FIG. 9 is a flowchart for explaining a flow of processing (a setting information management method) in the PC 11 according to this embodiment.

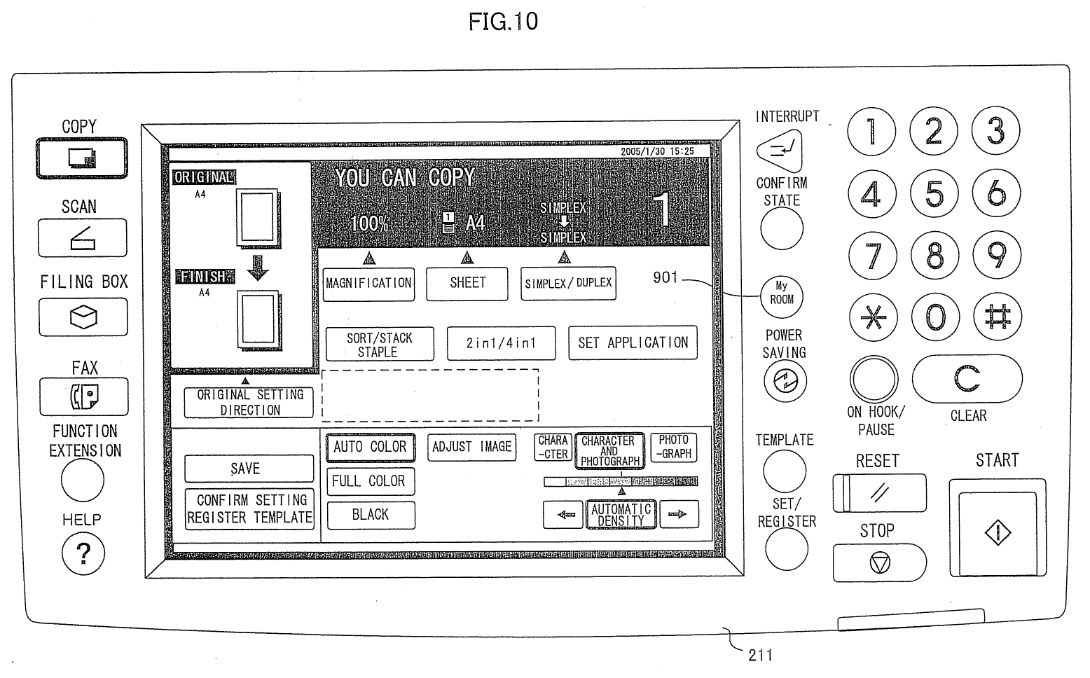

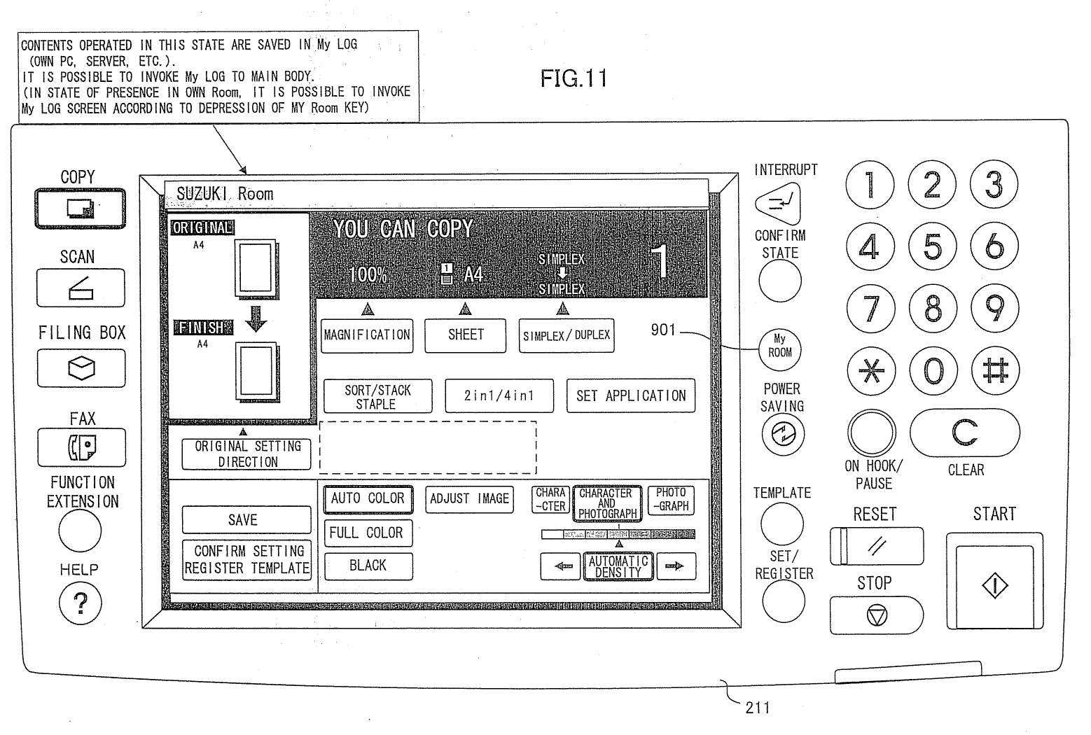

FIG. 10 is a diagram showing the interface screen 211 in a state before login of the image processing apparatus 21. When authentication processing (login) for a user is successful in the authentication processing unit 217 in the image processing apparatus 21 (here, a case in which a user name of the authenticated user is “Suzuki” is cited as an example), an operation screen indicated as “Suzuki ROOM” is displayed on the interface screen 211 as shown in FIG. 11. A history of setting operation by the user on the interface screen 211 shown in FIG. 11 is transmitted to, for example, the database 3 and the PC 11 and registered as history information of the setting operation by the user.

The history-information acquiring unit 101 acquires the history information registered as described above (a history-information acquiring step) (S101). The history information acquired by the history-information acquiring unit 101 is stored in, for example, the MEMORY 802.

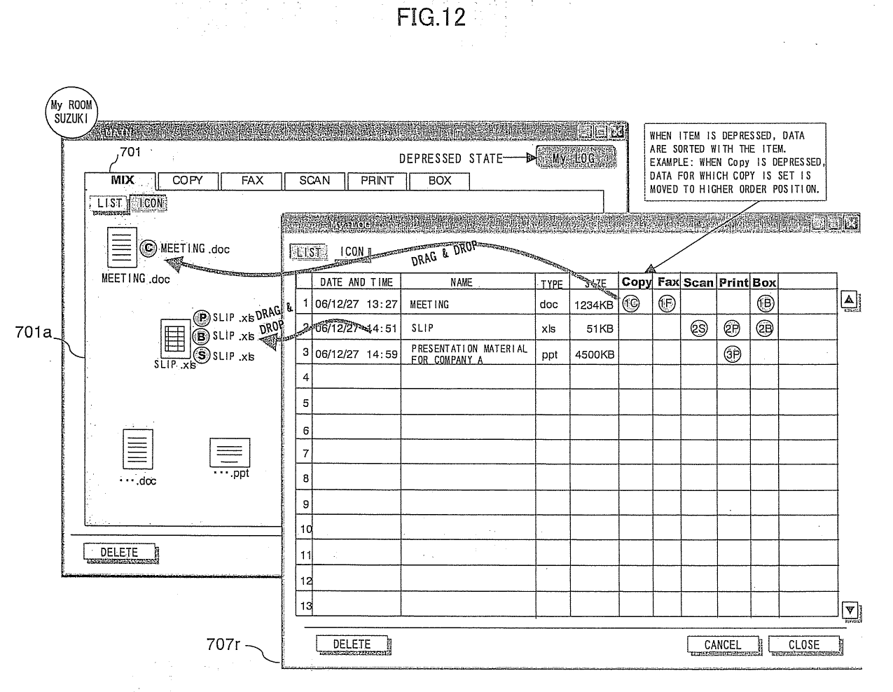

FIG. 12 is a diagram showing an example of screen display on the display 11a in a state in which a “My Log” button on a management screen displayed by depressing the “My Room” button 901 in the portal screen P shown in FIG. 6 is depressed. As shown in FIG. 12, the history-information displaying unit 102 displays a history list screen 707r in a form of associating a “setting data and time”, a “setting name”, a “type of a file to be subjected to processing setting”, a “data size of a file to be subjected to processing setting”, “setting contents concerning the copy function, the facsimile function, the scan function, the print function, and the box function”, and the like with one another as the history information acquired in the history-information acquiring step (a history-information displaying step) (S102).

The history-setting registering unit 103 registers, in association with the user, setting information corresponding to history information selected by an operation input to the operation inputting unit 11b of the user among the history information, which is displayed in the history list screen 707r by the history-information displaying step, in the database 3 (a history-setting registering step) (S103). Here, the selection of the history information is realized by dragging desired history information on the history list screen 707r and dropping the history information in a management screen of a function that the user desires to register (here, a management screen 701a shown in FIG. 12).

The setting-frequency determining unit 104 determines, independently from the processing in S101 to S103, a frequency of setting operation with the same setting contents by the user on the basis of an operation input or the like by the user in the operation inputting unit 11b and the interface screen 211 (a setting-frequency determining step) (S104).

The setting registering unit 105 registers, in association with the user, setting information determined as being repeatedly set at a frequency equal to or higher than a predetermined threshold (e.g., “five times in one month”) in the setting-frequency determining step in the database 3 (a setting registering step) (S105).

The identification-information acquiring unit 106 acquires, on the basis of login information and the like in the PC 11, identification information such as a user ID for identifying the user who attempts to display the management screen for managing the registered setting contents (an identification-information acquiring step) (S106).

The selected-function determining unit 107 determines, on the basis of an operation input of the user, a function selected by the user among the plural functions (a selected-function determining step) (S107). The determination on presence or absence of the selection of a function by the user is performed on the basis of a selection state of tabs 701 to 706 described later.

The display-information acquiring unit 108 acquires, from the database 3 (an external apparatus connected to the driver apparatus to be capable of communicating with each other), information on at least one of “setting information” and data registered in association with the user ID acquired in the identification-information acquiring step (a display-information acquiring step) (S108).

The display control unit 109 causes the PC 11 to display, in association with information on the function determined as being selected in the selected-function determining step, display objects (including at least one of characters and icons) associated with the information acquired in the display-information acquiring step in predetermined display areas (e.g., 701a to 706a and 701t to 706t described later) (a display control step) (S109). In this case, in the display control step, the display control unit 109 allocates the display objects to tab sheets (display areas) different for each of the functions and causes the PC 11 to display the display objects therein.

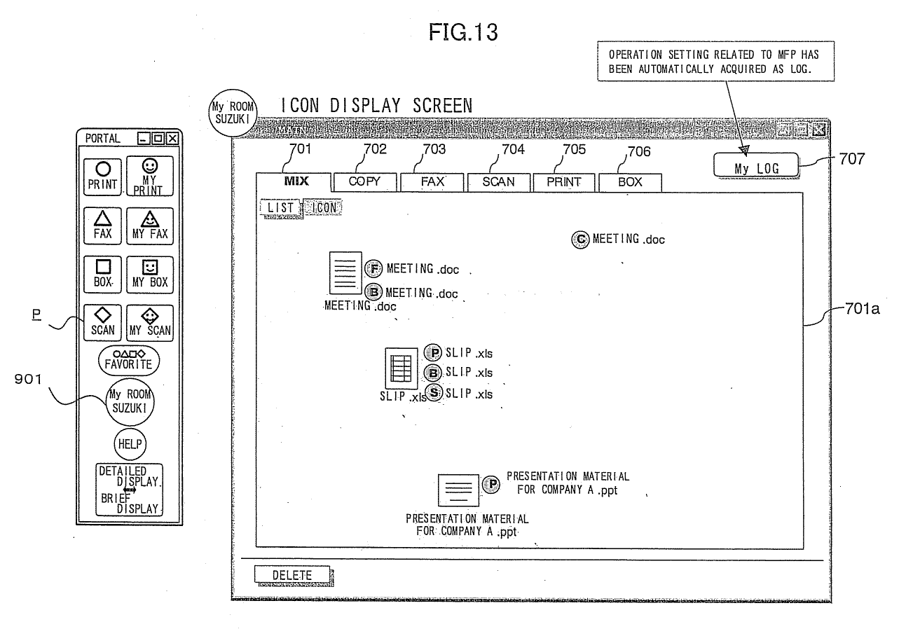

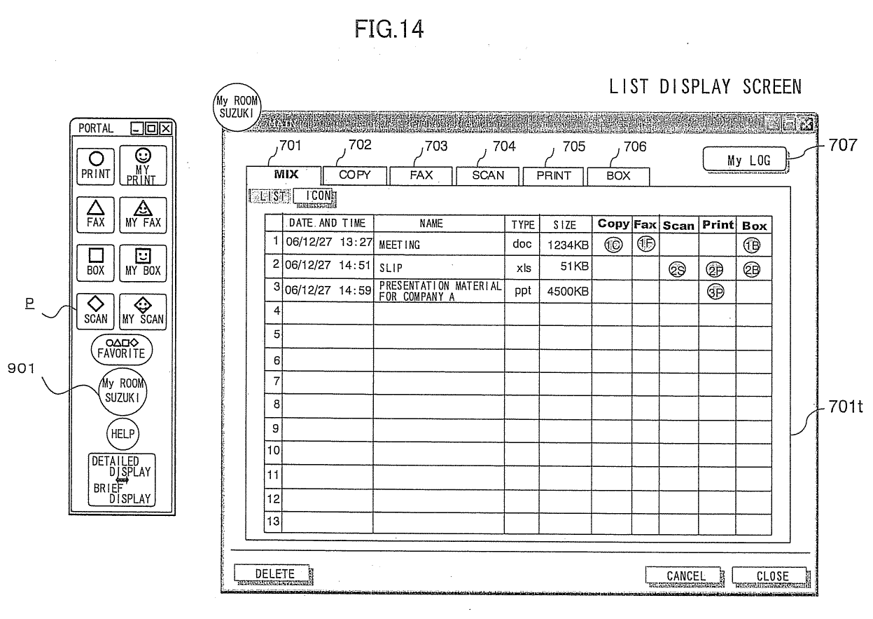

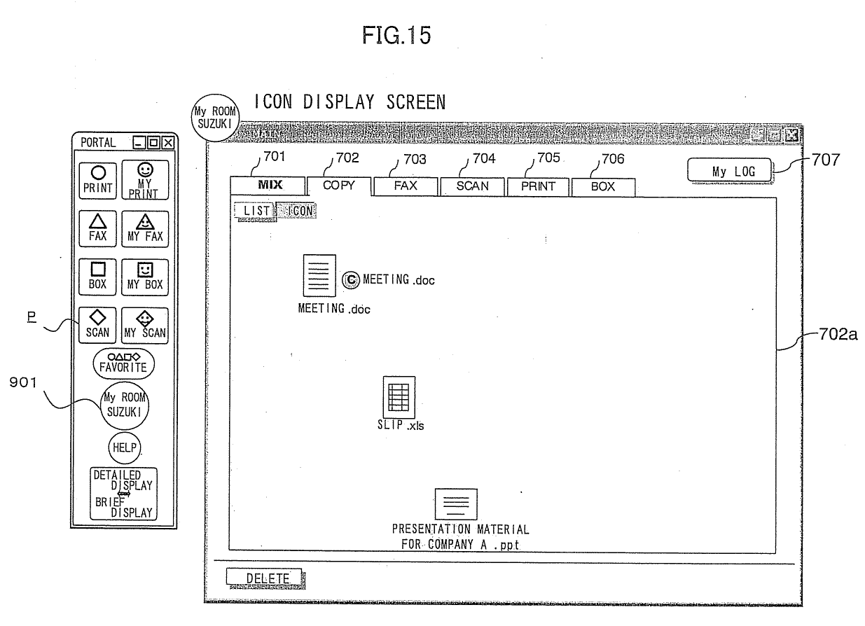

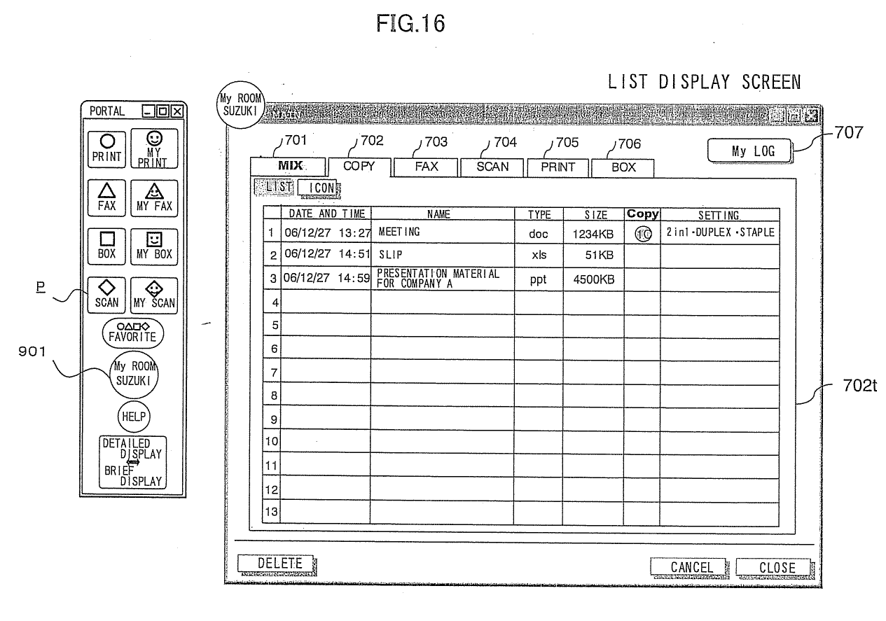

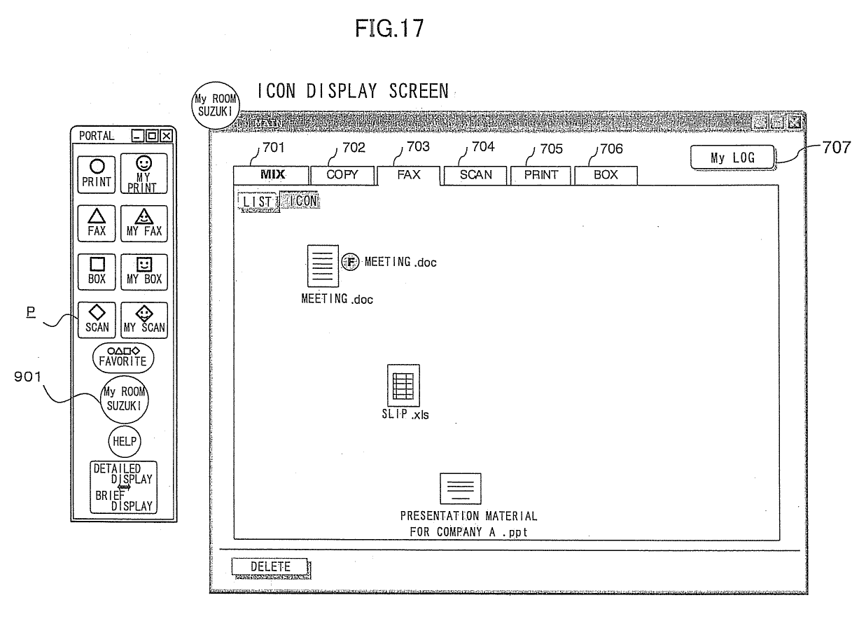

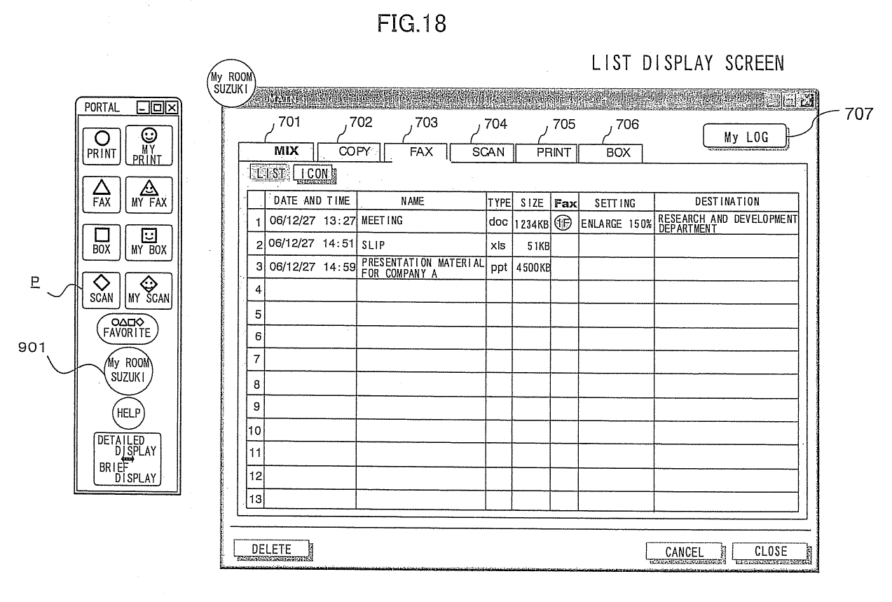

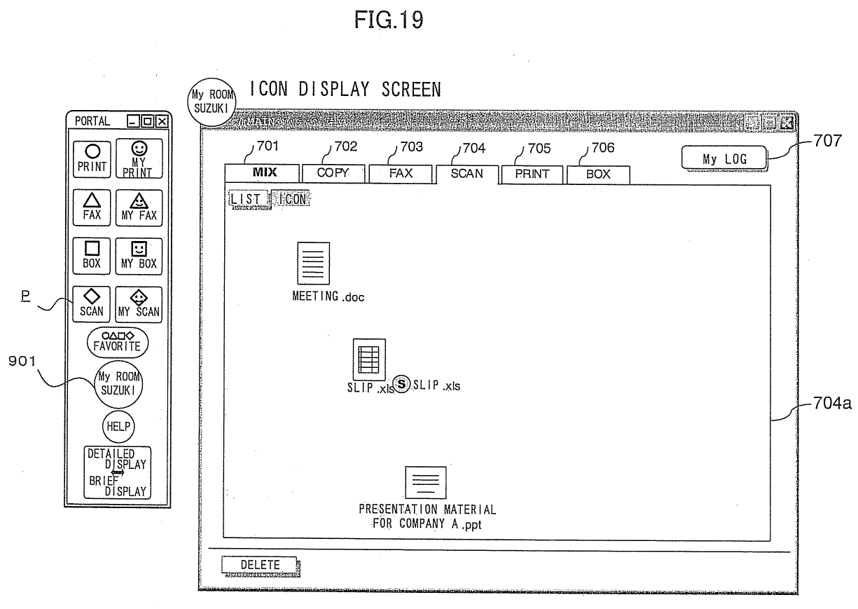

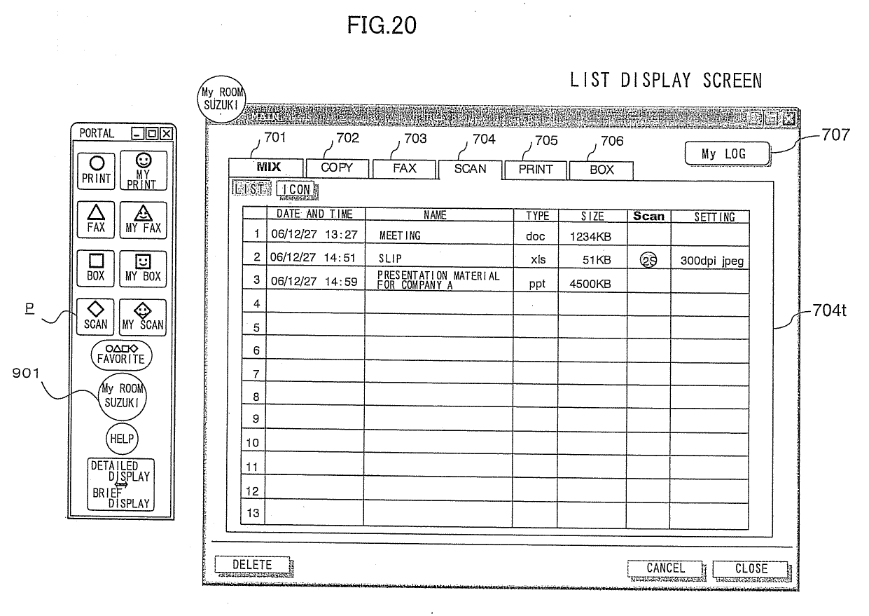

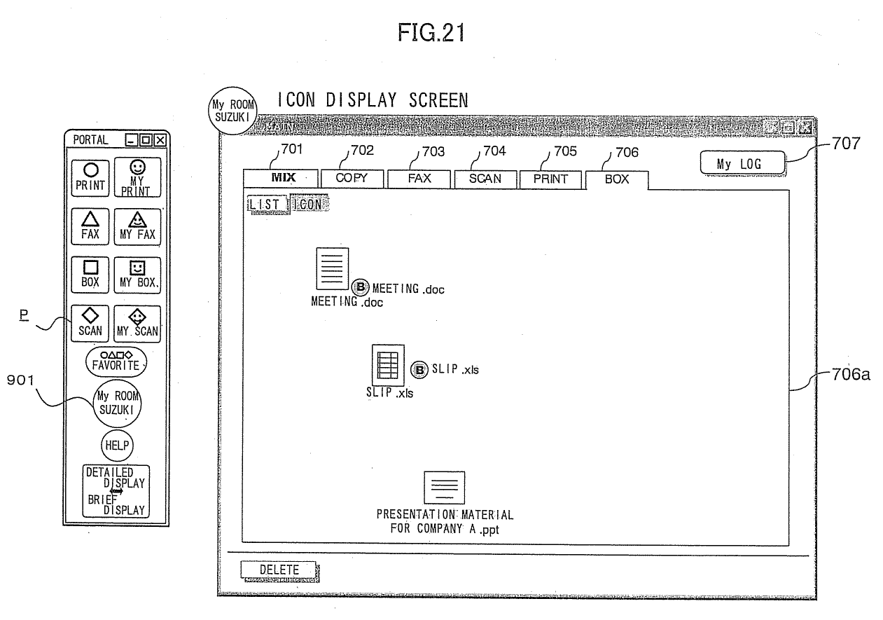

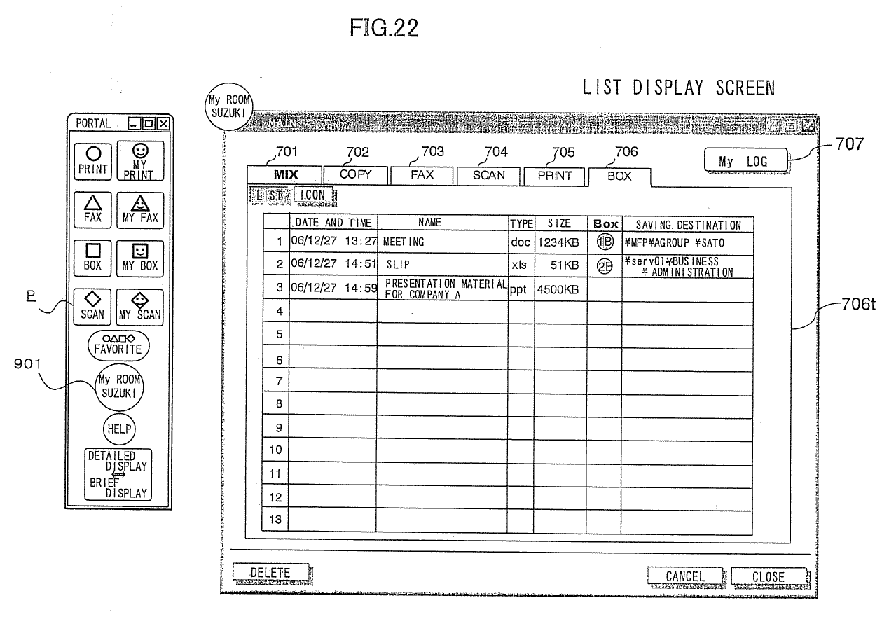

FIGS. 13 and 14 are diagrams showing a management screen for managing setting information indicating setting contents concerning all the processing functions (the copy function, the print function, the facsimile function, the scan function, and the box function) and document files, address book data, image data, and the like registered by the user. FIGS. 15 and 16 are diagrams showing a management screen for managing the setting information indicating the setting contents concerning the copy function and the document files, the address book data, the image data, and the like registered by the user. FIGS. 17 and 18 are diagrams showing a management screen for managing the setting information indicating the setting contents concerning the facsimile function and the document files, the address book data, the image data, and the like registered by the user. FIGS. 19 and 20 are diagrams showing a management screen for managing the setting information indicating the setting contents concerning the scan function and the document files, the address book data, the image data, and the like registered by the user. FIGS. 21 and 22 are diagrams showing a management screen for comprehensively managing the setting information indicating the setting contents concerning the box function and the document files, the address book data (for managing facsimile numbers and e-mail addresses), the image data, and the like registered by the user.

Specifically, FIGS. 13, 15, 17, 19, and 21 are diagrams showing states in which the information to be managed in the respective management screens is displayed as icons. In these management screens by the icon display, data for which schematic contents can be represented as images such as image data and document data are displayed as thumbnails.

In the management screens by the icon display, data themselves that can be processed by the various functions and the setting information concerning the respective functions related to the data are separately displayed as icons. The icons indicating the setting information are dropped on icons indicating desired data by drag and drop to make it possible to apply processing applied with the setting information to the desired data (e.g., when an icon “P” for print setting is dragged and dropped on an icon of image data, a printer driver in a state in which setting contents of the setting information are applied to the image data is started).

An icon indicating the setting information may be displayed in a pair with a specific data icon. However, by dragging and dropping only the data icon on desired data, processing with setting contents of the setting information can be executed on the desired data.

Moreover, by dragging and dropping the icon indicating the setting information on desired plural data icons, all of these plural data are processed by processing functions executed with setting contents on which the icon is dropped.

FIGS. 14, 16, 18, 20, and 22 are diagrams showing states in which the information to be managed in the respective management screens is displayed in a list format. In these management screen by the list display, setting contents for the respective functions are displayed with numbers in such forms as “1C”, “1F”, “2S”, “2P”, “3P”, “1B”, and “2B”. When an icon of each of the kinds of setting information displayed with the numbers in this way is selected (e.g., double click or depression is performed according to an operation input to the operation inputting unit 11b), a setting content corresponding to the icon selected is displayed as a popup.

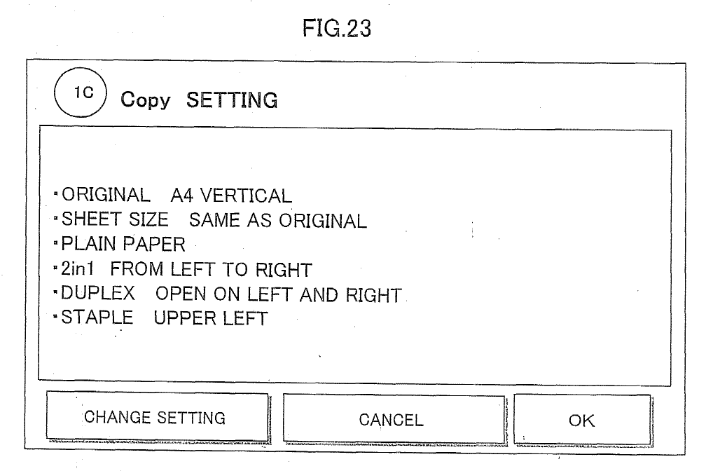

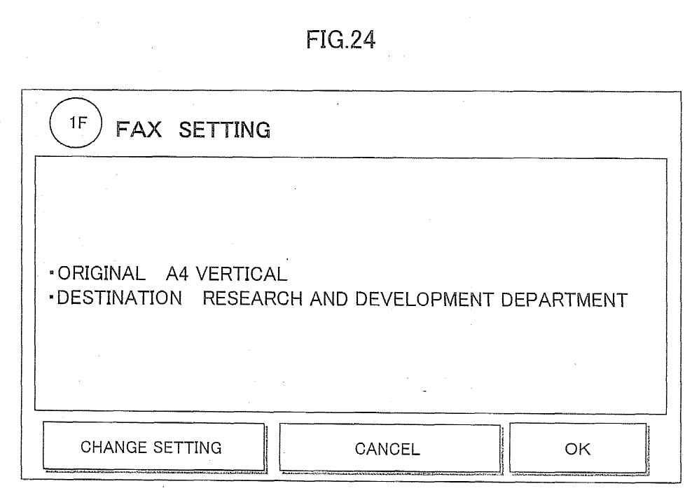

FIG. 23 is a diagram showing an example of a screen displayed as a popup when the setting information icon “1C” is selected. FIG. 24 is a diagram showing an example of a screen displayed as a popup when the setting information icon “1F” is selected. The user can change these setting contents by depressing a “Change Setting” button shown in FIGS. 23 and 24.

The respective steps in the processing (the setting-information management method) in the PC 11 are realized by causing the CPU 801 to execute a setting information management program stored in the MEMORY 802.

In the embodiment described above, the example in which the processing concerning the display control of the respective setting items on the setting screen is performed on the PC 11 is cited. However, it is also possible to perform the processing, for example, on the image processing apparatus 21. In other words, the image processing apparatus 21 may have functions equivalent to the history-information acquiring unit 101, the history-information displaying unit 102, the history-setting registering unit 103, the setting-frequency determining unit 104, the setting registering unit 105, the identification-information acquiring unit 106, the selected-function determining unit 107, the display-information acquiring unit 108, the display control unit 109, the display 11a, the operation inputting unit 11b, the CPU 801, and the MEMORY 802.

In the embodiment described above, the example in which the selection, the setting operation, and the like for the driver screens for the respective functions are mainly performed by mouse operation is described. However, the invention is not limited to this. It goes without saying that it is also possible to realize the selection, the setting operation, and the like for the driver screens with an operation input using the keyboard, the touch panel, and the like.

As described above, according to this embodiment, it is possible to manage setting information, saved data, and the like for the respective processing functions in the image processing apparatus of the individual user irrespective of the functions and manage data and settings in a form easy for the user to remember (e.g., for each work or for each document). Thus, it is possible to reduce a burden of management on the user.

In the explanation of this embodiment, the functions of carrying out the invention are recorded in the apparatus in advance. However, the invention is not limited to this. The same functions may be downloaded from a network to the apparatus or the same functions stored in a recording medium may be installed in the apparatus. As the recording medium, a form of the recording medium may be any form as long as the recording medium is a recording medium that can store a program and is readable by the apparatus such as a CD-ROM. The functions obtained by the installation or the download in advance in this way may be functions realized in cooperation with an OS (Operating System) or the like in the apparatus.

The invention has been explained in detail according to the specific forms. However, it will be apparent to those having ordinary skill in the art that various modifications and alterations may be made without departing from the spirit and the scope of the invention.

As described above in detail, according to the invention, it is possible to provide a technique that can contribute improvement of operability in performing management of setting contents in the driver apparatus that causes the image processing apparatus to execute the plural functions executable in the image processing apparatus on the basis of the setting contents registered for the respective functions.

What is claimed is:

1. A driver apparatus that causes an image processing apparatus to execute plural functions executable in the image processing apparatus on the basis of setting information registered for the respective functions, the driver apparatus comprising:
an identification-information acquiring unit configured to acquire identification information for identifying a user;
a display-information acquiring unit configured to acquire information on at least one of the setting information and data registered in association with the identification information acquired by the identification-information acquiring unit; and
a display control unit configured to cause the image processing apparatus to display display objects associated with the information acquired by the display-information acquiring unit in a predetermined display area as a list.

2. A driver apparatus according to claim 1, comprising a selected-function determining unit configured to determine, on the basis of an operation input of a user, a function selected by the user among the plural functions, wherein
the display control unit causes the image processing apparatus to display the display objects in association with information on the function determined as being selected by the selected-function determining unit.

3. A driver apparatus according to claim 1, wherein the display control unit allocates the display objects to display areas different for each of the functions and causes the image processing apparatus to display the display objects therein.

4. A driver apparatus according to claim 1, comprising:
a setting-frequency determining unit configured to determine a frequency of setting of setting information by the user; and
a setting registering unit configured to register, in association with the user, the setting information determined as being set at a frequency equal to or higher than a predetermined threshold by the setting-frequency determining unit.

5. A driver apparatus according to claim 1, comprising:
a history-information acquiring unit configured to acquire history information concerning a history of setting operation by the user;
a history-information displaying unit configured to display the history information acquired by the history-information acquiring unit; and
a history-setting registering unit configured to register setting information corresponding to history information selected by an operation input of the user among the history information displayed by the history-information displaying unit.

6. A driver apparatus according to claim 1, wherein the display objects include at least one of characters and icons.

7. A driver apparatus according to claim 1, wherein the display-information acquiring unit acquires, from an external apparatus connected to the driver apparatus to be capable of communicating with each other, information on at least one of the setting information and the data registered in association with the identification information acquired by the identification-information acquiring unit.

8. A setting information management method of performing management of setting information in a driver apparatus that causes an image processing apparatus to execute plural functions executable in the image processing apparatus on the basis of the setting information registered for the respective functions, the setting information management method comprising the steps of:
acquiring identification information for identifying a user;
acquiring information on at least one of the setting information and data registered in association with the identification information acquired in the identification-information acquiring step; and
causing the image processing apparatus to display display objects associated with the information acquired in the display-information acquiring step in a predetermined display area as a list.

9. A setting information management method according to claim 8, comprising the step of determining, on the basis of an operation input of a user, a function selected by the user among the plural functions, wherein
in the step of causing the image processing apparatus to display display objects, the image processing apparatus is caused to display the display objects in association with information on the function determined as being selected in the selected-function determining step.

10. A setting information management method according to claim 8, wherein, in the step of causing the image processing apparatus to display display objects, the display objects are allocated to display areas different for each of the functions and the image processing apparatus is caused to display the display objects therein.

11. A setting information management method according to claim 8, comprising the steps of:
determining a frequency of setting of setting information by the user; and
registering, in association with the user, the setting information determined as being set at a frequency equal to or higher than a predetermined threshold in the setting-frequency determining step.

12. A setting information management method according to claim 8, comprising the steps of:
acquiring history information concerning a history of setting operation by the user;
displaying the history information acquired in the history-information acquiring step; and
registering setting information corresponding to history information selected by an operation input of the user among the history information displayed by the history-information displaying step.

13. A setting information management method according to claim 8, wherein the display objects include at least one of characters and icons.

14. A setting information management method according to claim 8, wherein, in the display-information acquiring step, information on at least one of the setting information and the data registered in association with the identification information acquired in the identification-information acquiring step is acquired from an external apparatus connected to the driver apparatus to be capable of communicating with each other.

15. A setting information management program for causing a computer to execute management of setting information in a driver apparatus that causes an image processing apparatus to execute plural functions executable in the image processing apparatus on the basis of the setting information registered for the respective functions, the setting information management program causing the computer to execute:
an identification-information acquiring step of acquiring identification information for identifying a user;
a display-information acquiring step of acquiring information on at least one of the setting information and data registered in association with the identification information acquired in the identification-information acquiring step; and
a display control step of causing the image processing apparatus to display display objects associated with the information acquired in the display-information acquiring step in a predetermined display area as a list.

16. A setting information management program according to claim 15, comprising a selected-function determining step of determining, on the basis of an operation input of a user, a function selected by the user among the plural functions, wherein
in the display control step, the image processing apparatus is caused to display the display objects in association with information on the function determined as being selected in the selected-function determining step.

17. A setting information management program according to claim 15, wherein, in the display control step, the display objects are allocated to display areas different for each of the functions and the image processing apparatus is caused to display the display objects therein.

18. A setting information management program according to claim 15, comprising:
a setting-frequency determining step of determining a frequency of setting of setting information by the user; and
a setting registering step of registering, in association with the user, the setting information determined as being set at a frequency equal to or higher than a predetermined threshold in the setting-frequency determining step.

19. A setting information management program according to claim 15, comprising:
a history-information acquiring step of acquiring history information concerning a history of setting operation by the user;
a history-information displaying step of displaying the history information acquired in the history-information acquiring step; and
a history-setting registering step of registering setting information corresponding to history information selected by an operation input of the user among the history information displayed by the history-information displaying step.

20. A setting information management program according to claim 15, wherein, in the display-information acquiring step, information on at least one of the setting information and the data registered in association with the identification information acquired in the identification-information acquiring step is acquired from an external apparatus connected to the driver apparatus to be capable of communicating with each other.
